(19) United States
(12) Patent Application Publication
(10) Pub. No.: US 2023/0177978 A1
(43) Pub. Date: Jun. 8, 2023

(54) Textured learning aid with auditory key for the visual impaired

(71) Applicants: Charis Criddle, Canyon Lake, TX (US); Sarah Brooks, Austin, TX (US); Brittany Bishop, San Antonio, TX (US)

(72) Inventors: Charis Criddle, Canyon Lake, TX (US); Sarah Brooks, Austin, TX (US); Brittany Bishop, San Antonio, TX (US)

(21) Appl. No.: 17/548,229

(22) Filed: Dec. 10, 2021

Related U.S. Application Data
(60) Provisional application No. 63/124,467, filed on Dec. 11, 2020.

(51) Int. Cl. G09B 21/00; G09B 23/30

(52) U.S. Cl. CPC G09B 21/007; G09B 23/30

(57) ABSTRACT

A 3D printed assisted technology for the visually impaired may contain two separate, identical, low-cost, 3D printed models of cross-sectioned neuroanatomical structures. Both of these models may contain identical tactile, topographical sections that emphasize different systems of the brain. One model may contain pressable buttons and programmable audio components that present audio information to the future and correspond to features on the 3D model.

### STATEMENT OR PRIORITY

The present application claims priority to U.S. Provisional Application No. 63/124,467 filed on Dec. 11, 2020.

### BACKGROUND OF THE INVENTION

### Field of The Invention

The present invention relates generally to the fields of anatomy and particularly to devices and methods for the teaching thereof to the visually impaired.

### BACKGROUND OF THE INVENTION

Teaching of anatomical structures, such as the nervous system, commonly requires use of drawings and anatomical models. Teaching anatomy is particularly crucial in medical and other healthcare professions. The traditional teaching approach of cadaveric dissection has evolved into stationary or interactive textbooks, electronic textbooks, videos, computer-assisted learning, and other visual techniques.

However, current tools for purposes of teaching neuroanatomy are difficult for a visually impaired student to effectively use. For example, the majority of available anatomical teaching tools provide limited means for visually impaired students with the ability to self-assess their learning progress. Furthermore, three-dimensional learning models are often expensive and not widely available through a few tactile 3D models exist as teaching systems. For example, the Journal of Undergraduate Neuroscience Education discloses a low-cost tactile neuroanatomy tool for purposes of teaching the visually-impaired in an article by Diniz et al. titled “Development of Low-Cost Tactile Neuroanatomy Learning Tools for Students with Visual-Impairment.”

Other 3D models for purposes of teaching anatomy are disclosed in Chinese Patent Application No. CN105023295A and in Brazilian Patent Application No. BR102016010054A2. Importantly, while indicating that use of textured surfaces was helpful, Diniz noted that more specially designed learning aids for the visually impaired were needed.

### SUMMARY OF THE INVENTION

With the above in mind, the present invention advantageously provides a low-cost, 3D teaching system capable of having 3D printed tactile models. This 3D system uses a textured surface model to facilitate the visually-impaired user's ability to feel anatomical features. The system further includes an answer key having substantially the same shape as the textured model and configured to provide identification of the model's corresponding topographical impressions via auditory message played through a speaker. The presently disclosed system thereby provides a learning method aid that facilitates learning and self-assessment for the visually-impaired.

### BRIEF DESCRIPTION OF THE DRAWINGS

FIG. 1 is a top perspective view of the combined 3D printed assisted technology with a tactile learning model and a corresponding key model.

FIG. 2 is a top perspective of the tactile learning model of the 3D printed assisted technology.

FIG. 3 is a top perspective of the corresponding key model.

FIG. 4 depicts the audio circuit and speaker elements of a key model in accordance with certain embodiments.

### DETAILED DESCRIPTION

A clearer impression of the invention, and of the components and operation of systems provided with the invention, will become more readily apparent by referring to the exemplary, and therefore nonlimiting, embodiments such as those illustrated in the drawings.

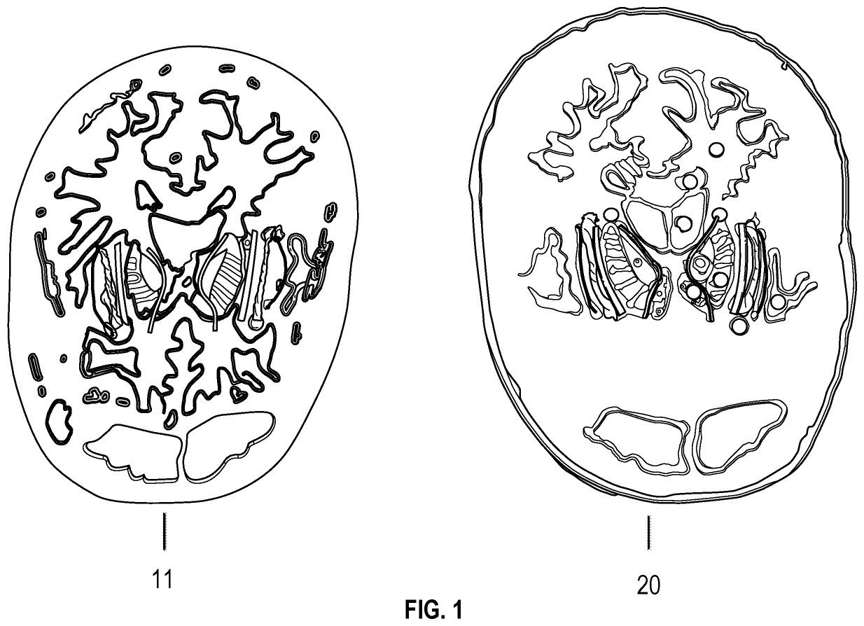

Referring now to FIGS. 1-4, certain embodiments of a three-dimensional learning aid for the visually-impaired may include a textured surface model 11 and a corresponding key model 20. The textured surface model 11 may represent a cross-section of an anatomical element such as the brain. The textured surface model 11 may include a plurality of model sections wherein each model section of said plurality of model sections corresponds to an area of the anatomical element to be learned by the user. For example, a textured surface model 11 of the brain may represent a cross-section featuring model sections corresponding to the thalamus and putamen. Moreover, each model section may utilize a section material that is tactilely distinct from the section material of any other model section. The texture surface model 11 may be configured to define an outer edge that conforms to the shape of the anatomical element (such as the cross-section of a brain).

The corresponding key model 20 may be configured to have substantially the same shape as the textured surface model 11. The key model 20 may include a corresponding plurality of key sections wherein each key section corresponds to one model section of the plurality of model sections. Each key section may include a button 21, or other mechanism, that will cause an audio message to be played through a speaker 30 when actuated. The audio message will reflect the particular area of the anatomical element mapped to the model section to which the key section corresponds.

In certain embodiments, including those modelling cross-sections of the brain, the models (both textured surface model 11 and key model 20) may be 3D-printed. An image of the cross-section may be obtained via any method known in the art such as downloading said image from the Visible Human Project. The image may then be imported into conventional editing software to be rendered in black and white More sophisticated image manipulation software (such as lnkscape) may then be applied to convert the image into a vector-based image. The vector-based image may then be imported into modelling software (such as Fusion 360 or SOLIDWORKS) configured to generate a file for use with a 3D printer. The models may then be printed. For the textured surface model 11, the section materials may then be applied to the textured surface model 11 via any conventional method for adhering the selected section materials to the printed 3D model material.

The audio message may be stored in any conventionally known format (such as .mp3 or .mp4a). Buttons 21, or other actuators, may be disposed on a first surface of the key model 20. Sound modules 31 (such as those sold by Invite By Voice) may disposed on a second surface, opposite said first surface, of the key model 20 wherein each button 21 is coupled to a sound module 31. The audio message data may be stored in the sound modules 31 (such as via transfer from a personal computer). The sound modules 31 may be further coupled to a speaker 30 configured to play the audio message data from a sound module 31 when the corresponding button 21 (or actuator) is actuated.

The 3D printed assistive technology for the visually-impaired includes two separate and identical 3D printed models of cross-sectioned, neuroanatomical structures. These two identical 3D models, illustrated in FIG. 1, contain topographical layers representing different systems in the brain. The topographical layers may include differently textured material 10 attached directly on top of the teachable areas of the structure.

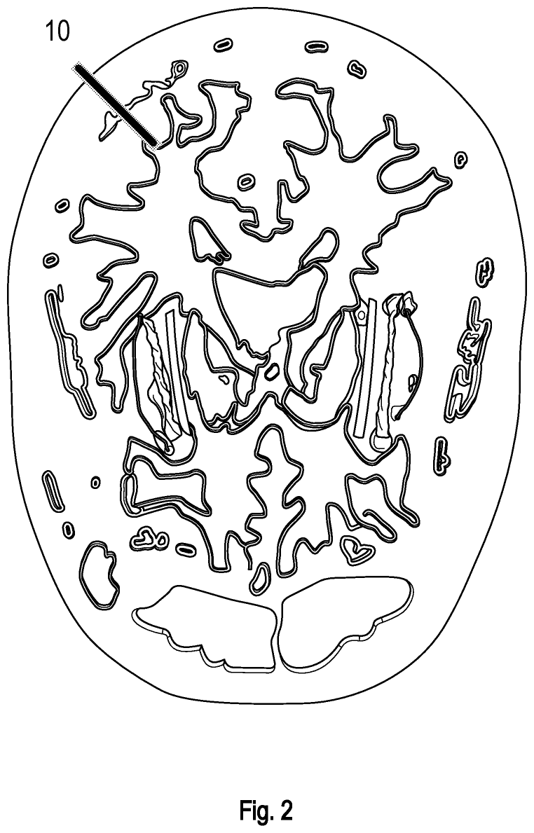

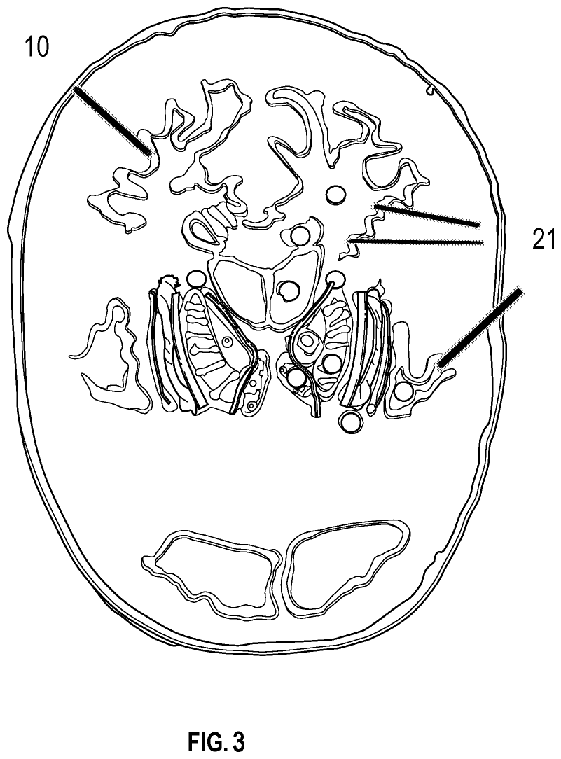

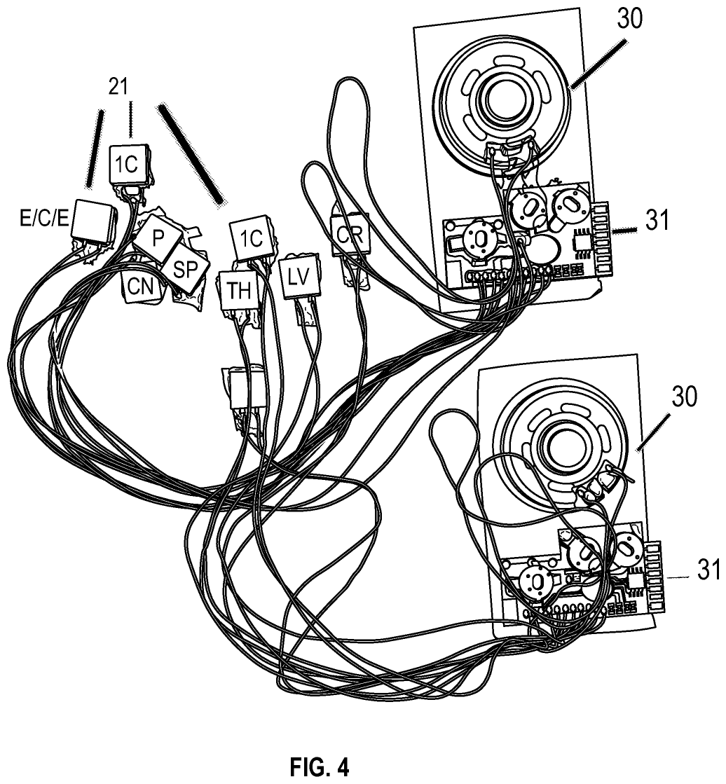

The first 3D model illustrated in FIG. 2 does not contain an audio component. The second, identical 3D model illustrated in FIG. 3 contains additional programmable features capable of presenting audio information to the user. The student user may press on the corresponding button 21 to the anatomical feature to hear information about that feature. FIG. 4 illustrates these programmable features in more detail.

1. A three-dimensional teaching tool comprising:
a surface member a first face and a second face, wherein said first face is configured with a first set of contours; and
an answer key element corresponding to said surface member and having a second set of contours, wherein said second set of contours correspond to said first set of contours.

2. The tool of claim 1 wherein said first set of contours corresponds to human anatomical structures.

3. The tool of claim 2 wherein said human anatomical structures are elements of the human brain.

4. The tool of claim 1 wherein said surface member is substantially shaped like a human brain.

5. The tool of claim 4 wherein said answer key element has substantially the same shape as said surface member.

6. The tool of claim 5 wherein said answer key element comprises at least one actuator and at least one sound producing device.

7. The tool of claim 6 wherein said at least one actuator is configured to cause a sound to be played via said at least one sound producing device.

8. The tool of claim 6 wherein said sound corresponds to an element of the human brain.
